(19) United States
(12) Patent Application Publication
(10) Pub. No.: US 2016/0210571 A1
(43) Pub. Date: Jul. 21, 2016

(54) ANALYSIS OF PROJECT MANAGEMENT

(71) Applicant: International Business Machines Corporation, Armonk, NY (US)

(72) Inventors: Michael D. Amundson, Oronoco, MN (US); Jason D. Greenwood, Rochester, MN (US); Brad J. Rawlins, Fishkill, NY (US); Zelun Tie, Rochester, MN (US)

(21) Appl. No.: 14/744,785

(22) Filed: Jun. 19, 2015

Related U.S. Application Data
(63) Continuation of application No. 14/601,477, filed on Jan. 21, 2015.

(51) Int. Cl. G06Q 10/06

(52) U.S. Cl. CPC G06Q 10/06312; G06Q 10/067

(57) ABSTRACT

The method includes determining a plurality of metrics for the project, the project having a plurality of subprojects. The method also includes accessing data for each metric from the plurality of metrics, the data concerning a subproject from the plurality of subprojects. The method also includes building a table having the data for a metric matched to the subproject. The method also includes calculating a numerical score based off of the table that represents progress of a first subproject relative to a second subproject with regard to the metric. The method also includes creating a visualization that includes the plurality of metrics and the numerical score of the first subproject.

### BACKGROUND

The present disclosure relates to data processing, more particular aspects relate to operator interface with visual structure or function dictated by intended use.

During production of a product, e.g., construction of a semiconductor design, it is desirable to gather status of the project design (and project sub-designs) at various stages. This status might include specific technical information as well as schedule tracking. It is common to include this information in a spreadsheet or presentation including the raw data as well as line/bar graphs showing progression over time and also an extrapolation into the future. Such data is then presented to appropriate parties in one or more charts which may be limited in scope or complicated in nature. For example, one chart may show timing statistics for a sub-design while another shows congestion and does not provide a holistic view of all metrics for all such sub-designs.

### SUMMARY

According to embodiments of the present disclosure, a method, a system, and a computer program product are provided for visualizing a project on a computing device.

One embodiment is directed toward a method of visualizing a project on a computing device. The method includes determining a plurality of metrics for the project, the project having a plurality of subprojects. The method also includes accessing data for each metric from the plurality of metrics, the data concerning a subproject from the plurality of subprojects. The method also includes building a table having the data for a metric matched to the subproject. The method also includes calculating a numerical score based off of the table that represents progress of a first subproject relative to a second subproject with regard to the metric. The method also includes creating a visualization that includes the plurality of metrics and the numerical score of the first subproject.

Another embodiment is directed toward a system of visualizing a project. The system includes a memory. The system also includes a processor circuit communicatively coupled to the memory. The system also includes a visualization engine communicatively coupled to the memory and the processor circuit. The visualization engine is configured to determine a plurality of metrics for the project, the project having a plurality of subprojects. The visualization engine is configured to access data for each metric from the plurality of metrics, the data concerning a subproject from the plurality of subprojects. The visualization engine is configured to build a table having the data for a metric matched to the subproject. The visualization engine is configured to calculate a numerical score based off of the table that represents progress of a first subproject relative to a second subproject with regard to the metric. The visualization engine is configured to create a visualization that includes the plurality of metrics and the numerical score of the first subproject.

Another embodiment is directed toward a computer program product for visualizing a project. The computer program product includes a computer readable storage device having a computer readable program stored therein, wherein the computer readable program, when executed on a computing device, causes the computing device to determine a plurality of metrics for the project, the project having a plurality of subprojects. The computer readable program causes the computing device to access data for each metric from the plurality of metrics, the data concerning a subproject from the plurality of subprojects. The computer readable program causes the computing device to build a table having the data for a metric matched to the subproject. The computer readable program causes the computing device to calculate a numerical score based off of the table that represents progress of a first subproject relative to a second subproject with regard to the metric. The computer readable program causes the computing device to create a visualization that includes the plurality of metrics and the numerical score of the first subproject.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a high-level block diagram of a system for creating a visualization of a project, according to various embodiments.

FIG. 2 illustrates a flowchart of a method for creating a visualization for a project, according to various embodiments.

FIG. 3 illustrates a flowchart of a method for calculating a score for a subproject, according to various embodiments.

FIG. 4 illustrates a flowchart of a method for creating an abstraction for a project, according to various embodiments.

FIG. 5 illustrates a graphical user interface (GUI) selection window for interacting with a visualization, according to various embodiments.

FIG. 6 illustrates a table of data fields for subprojects and respective scores, according to various embodiments.

FIG. 7 illustrates a table that demonstrates an abstraction, according to various embodiments.

FIG. 8 illustrates a visualization of three subprojects, according to various embodiments.

FIG. 9 illustrates a visualization that includes a rank/score metric and a goal, according to various embodiments.

FIG. 10 illustrates a visualization that includes a symmetric goal, according to various embodiments.

FIG. 11 illustrates a visualization of an abstraction, according to various embodiments.

FIG. 12 illustrates a block diagram of automated computing machinery, according to various embodiments.

While the invention is amenable to various modifications and alternative forms, specifics thereof have been shown in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present disclosure relates to data processing, more particular aspects relate to operator interface with visual structure or function dictated by intended use. For example, aspects of the present disclosure relate to creating a visualization of progress toward a project. The project can be broken down into one or more subprojects and a score can be determined for fulfillment of a metric relative to other subprojects. The score is included in the visualization. While the present disclosure is not necessarily limited to such applications, various aspects of the disclosure may be appreciated through a discussion of various examples using this context.

To counteract a lack of a holistic view, a visualization, e.g., a chart, might be shown which includes all data but the chart would be very complex and hard to understand. Other chart types can be used (e.g., spider chart) but other chart types become overly-complicated for most projects due to the plethora of subprojects.

Aspects of the present disclosure simplify the visualization process and provide an easy-to-understand visualization that highlights the areas of interest. A visualization tailored to project management can actually improve time to market by reducing process complexity and allowing a development team to focus on the most important issues. The visualization relays a vast amount of information while reducing overall complexity. The most important items are highlighted and compared to the desired goal (for that point in time/in the development stage). The visualization can be configured to visualize a chip design project. For example, a chip design project may utilize several hierarchical sub-designs to reduce overall effort/complexity as well as turn-around time. There may be various projects that can be visualized. References may be made throughout this disclosure of a chip design project, but other projects are contemplated, such as building design, construction planning, or any type of general project management. Aspects of the present disclosure can use follow-on libraries such as the Dojo JavaScript library.

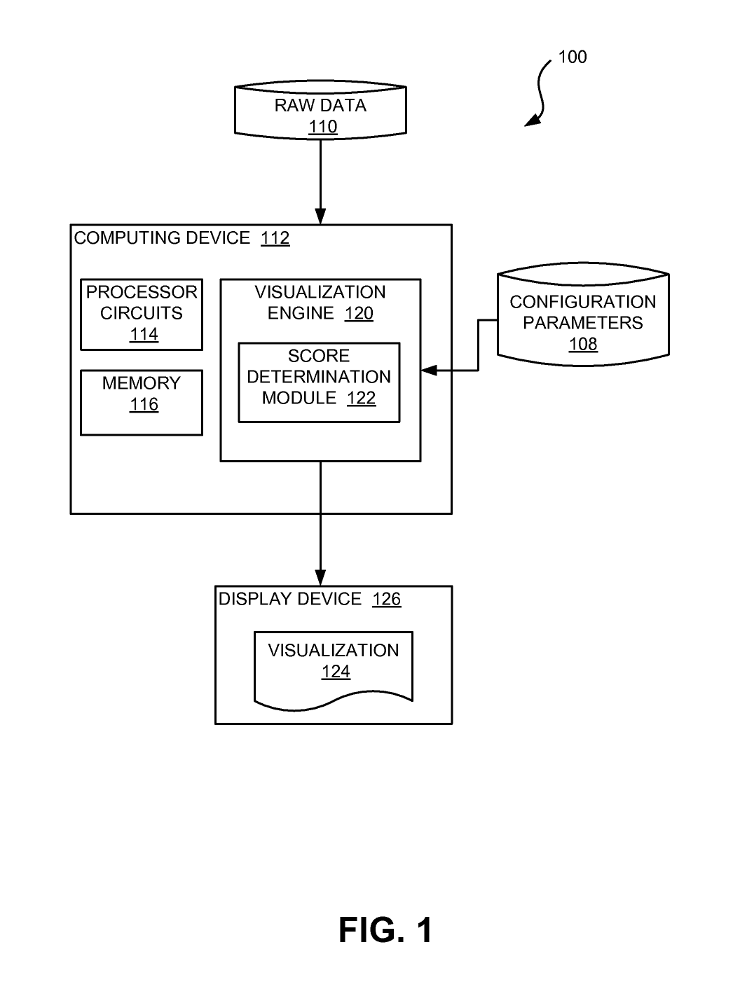

FIG. 1 illustrates a high-level block diagram of a system 100 for creating a visualization of a project, according to various embodiments. The system 100 utilizes a computing device 112 to create a visualization 124 from raw data 110 and configuration parameters 108.

The raw data 110 can be stored in a repository, e.g., a database. The raw data 110 has various values of properties of the project. For example, for a circuit design project, the raw data 110 includes the performance testing and simulation data for the circuit design. In various embodiments, the raw data 110 is a numeric value that can be interpreted by the computing device. The raw data 110 can also include various metadata tags to indicate a particular configuration category. The raw data 110 can pertain to a variety of metrics, e.g., in the circuit design scenario: timing, congestion, checking, discrete Fourier transform, etc.

The configuration parameters 108 are parameters that are used to categorize the raw data 110. Uncategorized raw data 110 may not be as useful to the computing device 112 as categorized data. The configuration parameter 108 is a configuration file, according to various embodiments. The configuration file includes the various metrics that apply to the raw data 110. For example, the configuration file informs the computing device that the timing metric for a sub-circuit is read from a particular range of table values within a raw data database. The configuration parameters 108 can also control how the visualization 124 is constructed (e.g., weights, goal percentage, etc.).

The computing device 112 includes one or more processor circuits 114, and memory 116. The one or more processor circuits 114 may be a device that is configured to perform processing for a computing device 112, e.g., a central processing unit. The memory 116 may be communicatively coupled to the one or more processor circuits 114. The memory 116 stores various instructions for the one or more processor circuits 114 to process. The one or more processor circuits 114 may perform the processing of a visualization engine 120.

The visualization engine 120 may implement creating the visualization 124 from the raw data 110 using the configuration parameters 108. The visualization engine 120 performs various operation as described herein. In various embodiments, the visualization engine 120 has a score determination module 122. The score determination module 122 determines a score for the raw data 110 for one or more subprojects. The score is a representation, e.g., a numerical representation, of the progress of a first subproject toward a metric relative to a second subproject. In various embodiments, the score is a ranking or is influenced by a ranking. The score can also be relative to a certain metric. For example, a timing metric value of 10 ms, may have an automatic score of 30 while a timing metric value of 4 ms may have an automatic score of 100.

The computing device 112 may output a visualization 124 that is produced by the visualization engine 120 and by utilizing the score of a subproject. The visualization 124 may be displayed on a display device 126. The visualization 124 is a visual conveyance of the raw data 110 organized by the various subprojects of a project. The visualization 124 is a spider chart according to various embodiments. A user of the computing device 112 may interact with the visualization 124. The visualization 124 includes any number M of subprojects (or subcircuits in the case of a circuit design project) on any number N of axes (which may be dependent or independent).

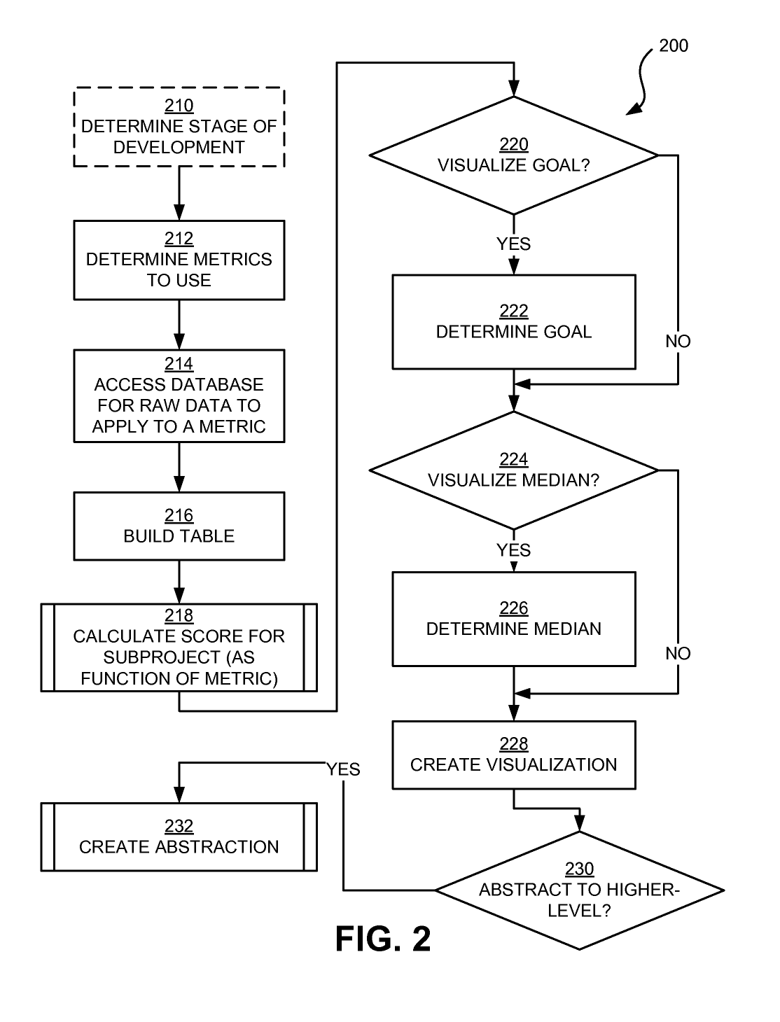

FIG. 2 illustrates a flowchart of a method 200 for creating a visualization for a project, according to various embodiments. The method 200 involves accessing a repository for raw data, organizing the raw data, scoring the organized data, and creating the visualization using the scored data. In various embodiments, the visualization for the project may include one or more subprojects. The method 200 may optionally include a goal, a median, or data for a subproject being abstracted to create a summary of a project. Aspects of the method 200 may be performed by the visualization engine. The method 200 may begin at operation 210.

In operation 210, the visualization engine may determine the stage of development of the project. The stage of development may be based on time, according to various embodiments. For example, the stage of development for a circuit design project is one week. After one week, then the stage of development is one week in. The stage of development may also be milestone-based. For example, a circuit design project may have a stage of development milestone that involves performing a successful simulation on the proposed design of the project. The stage of development of the project would be whether the project is pre-simulation or post-simulation. Likewise, any subprojects would be measured by whether the subprojects are pre-simulation or post-simulation, even if two subprojects have different progress inputs toward a simulation. For example, if subproject A takes 3 weeks to get to a simulation, but subproject B takes 1 week to get to a simulation, then after a week the milestone is still whether a subproject has achieved the simulation. The stage of development may be predicated by a questionnaire or by input from a user. In various embodiments, the user may be a project manager or someone that accesses the visualization. In various embodiments, determining the stage of development may be optional.

In operation 212, the visualization engine can determine the plurality of metrics. A metric is a category of measurement for data. For a circuit design project, possible metrics include slack, compression, and utilization. For a circuit design project, possible metrics include information related to timing, physical design, verification, functional test, and any other aspects of circuit design. For example, timing may include metrics for various timing tests including worst slack, number of misses, total negative slack, minimum/maximum capacitance violations, or minimum/maximum transition time violations. Physical design may include metrics such as number of ports, number of nets, number of cells, total cell area, size of the physical outline, metal ceiling, average fanout, area to latch ratio, utilization, density, congestion, or results of circuit checks. In various embodiments, the plurality of metrics can be responsive to what the stage of development of the project currently is in. For example, if the stage of development is pre-simulation, then the various metrics may be more influential than in a post-simulation. For example, if the stage of circuit design development is pre-placement, then the various metrics may be more influential than in a post-placement or post-routed environment. The stage of development may be further broken into phases. For example, the development may be broken into any number of possible phases. If there are three phases, a first phase, a second phase, and a third phase, then the first phase may correspond to a first set of metrics, the second phase corresponds to a second set of metrics, and a third phase corresponds to a third set of metrics. The first, second, and third set of metrics may have overlap between metrics. For example, a compression metric may be present in both the first and third set of metrics. In various embodiments, the set of metrics may be identifiable with the phase.

In operation 214, the visualization engine accesses data for each metric from the plurality of metrics. The data may concern a subproject from the plurality of subprojects. For example, the data can be a metric value for slack for a sub-design (i.e., the subproject) of an integrated circuit. In various embodiments, the visualization engine can access a repository, e.g., a database, for the raw data. Metric data for a phase may also be pulled for previous phases of development. For example, if a subproject has three phases, then accessing the data for the third phase may also include accessing data for the first phase.

In operation 216, the visualization engine builds a table having the plurality of metrics matched to a plurality of subprojects from the project. The building a table may refer to organizing the raw data to fit into one or more metrics. The table is a logical construction that relates the metrics to one or more subprojects. In various embodiments, the table relates the metrics to one or more subprojects and the stage of development of the subproject. An example of the table is provided further herein. The table may be represented via an in-memory database.

In operation 218, the score determination module calculates a score for the subproject. In various embodiments, the score is a numerical score. Alternatively, the score can be a grading, e.g., A, B, C, that is relative to other subprojects based on the plurality of metrics. For example, the score represents progress of a first subproject relative to a second subproject with regard to the plurality of metrics. The calculation of the score may be described further herein.

In operation 220, the user may indicate whether to visualize a goal for the various metrics. The project may have a particular goal for each metric. The goal is a property of an idealized project. For example, the goal may be a metric of a project with a particular value. For example, the congestion metric of a chip design may be seventy-two but the goal may be seventy-five. If the user desires to include a goal, then the method 200 continues to operation 222.

In operation 222, the visualization engine may determine a goal value for each metric from the plurality of metrics in the project. The goal for the subproject metric may be affected by the stage of development of the subproject. For example, an earlier stage goal for an earlier stage subproject may be reduced when compared to a later stage goal for a later stage subproject. The goal may be determined with input from the user or by predicted by the visualization engine based on an ideal design. For example, if a particular design of the project has the highest metrics of all of the designs of the project, then the metrics/properties of the particular design may be designated as the goal. The user may also designate a goal for a metric based on user experience.

The goal for each metric is fluid and may be based on human judgment (from a user) or computer analytics. For example, computer analytics can provide a goal based on a history of the current or other designs at a similar stage of development. A historical project may be a project that represents an idealized project that was done in the past. For example, the historic project can take the metrics for a production chip that was created in the past. In various embodiments, the historical project may have an average of the metrics of the last 10 projects that were created. The goal may be provided as an overlay for the visualization and may be a shape. The shape of the goal may be symmetric for consistency. A symmetric goal shape can be achieved by adjusting the min/max for each axis in order to visually align the goal with a specified percentage from the center point (e.g., 25%). For example, some percentage “p” from the center point will result in a target value “t” for each axis. If the goal is “g”, current min as “m”, current max as “x”, then if current goal<target value, the visualization engine may adjust minimum value as follows: New min=100g−x(p)/100−p.

If the current goal>target value, then the visualization engine may adjust maximum value as follows: New max=(100g−m(100−p))/p.

In operation 224, the user may indicate to the visualization engine whether to visualize the median. The median is a median value for each metric for a plurality of projects or subprojects. If the user indicates that a median is desired in operation 224, then the visualization engine overlays the median as a shape on the visualization. In operation 226, the visualization engine determines a plurality of median metric values for the project based on a plurality of metric values for a subproject. The various designs of a project may each be collected and the median values can be determined. For example, for a particular project, several designs of current and past subprojects (at earlier stages of development) may be evaluated to determine the median. In various embodiments, the median value may be the goal. In various embodiments, the median shape conveys quality of the design as a whole by limiting the visual impact of outliers. The median can also be for each metric and can be based on the current data set or a history of similar data from other projects.

In operation 228, the visualization engine creates the visualization based on the plurality of metrics and the numerical score of the one or more subprojects. In various embodiments, the visualization is a visual representation of the various metrics of the project and the corresponding subprojects. The visualization can be graph, e.g., a spider chart. The visualization may also include the various options previously selected by the user. For example, the user may have selected to visualize a goal and a median in operations 220 and operation 224.

If median visualization is desired, then the visualization engine may create a visualization using each median metric value. Likewise, if a visualization including the goal is desired, then the visualization engine creates a visualization using the goal value for the project.

In various embodiments, the visualization engine aligns the goal value with a specified percentage from a center of the visualization by adjusting a minimum and a maximum for an axis of the visualization. For example, if the goal value for slack is 100, and the axis for slack starts at 0 and ends at two-hundred, and the user specifies that a desired percentage from the center is 40%, then the maximum can be increased from two-hundred to two-hundred twenty. The visualization engine then creates the visualization that includes the goal value for each metric.

In operation 230, the user indicates a desire to abstract the various subprojects for the project to a high-level visualization. In operation 232, the visualization engine creates an abstraction by accessing a goal value for a metric, and determining a percentage fulfillment of the goal value by the metric from the subproject, and creating an abstraction based on the percentage fulfillment. The creation of an abstraction can be described further herein.

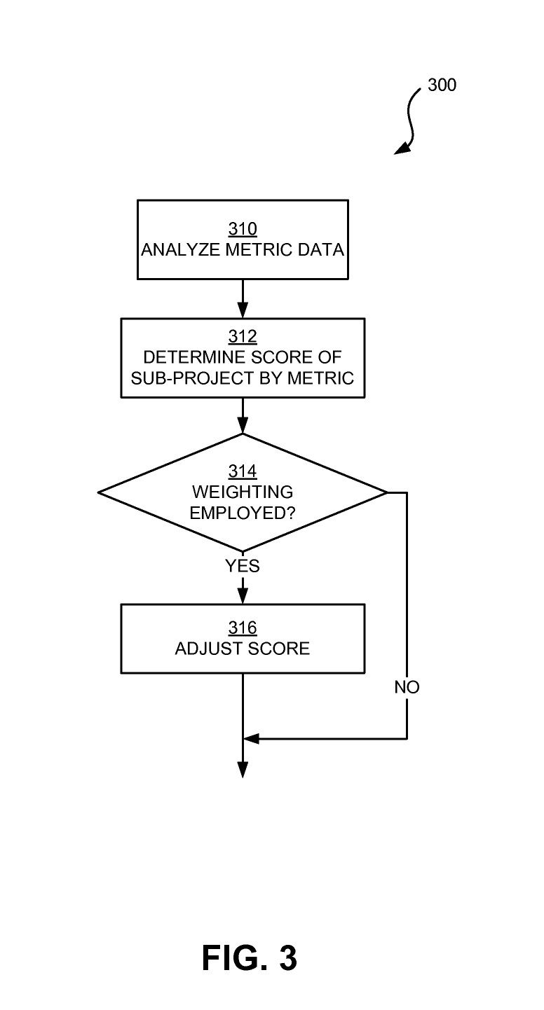

FIG. 3 illustrates a flowchart of a method 300 for calculating a score for the subproject, according to various embodiments. The method 300 may correspond to operation 218 of FIG. 2. The score may be determined by the score determination module and may be based on the value of a metric relative to other subprojects. Examples of the method 300 are described further herein.

In operation 310, the score determination module analyzes the data for the plurality of metrics of a first subproject. The score determination module may access the database or the table for the data relating to the values for the plurality of metrics.

In operation 312, the score determination module determines the score of the first subproject based on the relationship of a first metric from first subproject to the first metric from a second subproject. The score may be determined based on a rank according to various embodiments. For example, various subprojects may have different values for the metric. The score determination module can rank the values of the metric as a function of each subproject. For example, for three subprojects, subproject A, subproject B, and subproject C, each subproject can be ranked according to the slack metric. If the ranking is subproject B, subproject A, and subproject C, then a score can be determined for each of the subprojects using the slack metric, as well as the rankings for the other rankings. For example, in a circuit design project, a ranking can be applied among peers (e.g., other sub-circuits/subprojects on the same design/project) or against a history of similar data from other designs for each metric. The score determination module may rank the subprojects from “best” (i.e., having the most favorable performance for the design) to “worst” for the given metric. Different metrics may have different sorting order (e.g., slack is decreasing, congestion is increasing). The score determination module can assign a rank order for each sub-circuit where the best is equal to first rank and the worst is equal to the last rank.

In various embodiments, the score may be calculated independent of any rank. For example, a metric value for a subproject may be translated into a score without regard to how the subproject metric compares to other subproject metrics. Thus, if a compression metric for subproject A is 50, and for subproject B is 40, then subproject A may be scored higher, even if subproject A has a worse rank than subproject B.

In operation 314, the score determination module can determine whether weighting is employed. If weighting is employed, then the rank of the subproject in one metric can be more significant than the rank of the subproject in another metric. In operation 316, the score determination module can weigh the numerical score by applying a weight for the first metric. The weight is a value that reduces or increases the score. The weight applies to a particular metric and may be applied equally to all subprojects within a project. Different metrics may have different weights. In various embodiments, a weighting function may be employed by the score determination module. The weight may be based on a natural number, e.g., a positive integer.

The score determination module may multiply rank order by the specified weight and add to total rank for the subproject. In various embodiments, each subproject has a rank value with highest rank constituting the worst (and lowest rank is best). According to various embodiments, the score determination module may optionally provide a zero weight to any subproject with metric better than the goal. For example, if subproject A has a score of 20 and the goal is 10, then subproject A is ahead of the goal and any weights provided to subproject A can be removed to determine an unweighted score. The unweighted score may allow a user to compare the effect of weight on the score.

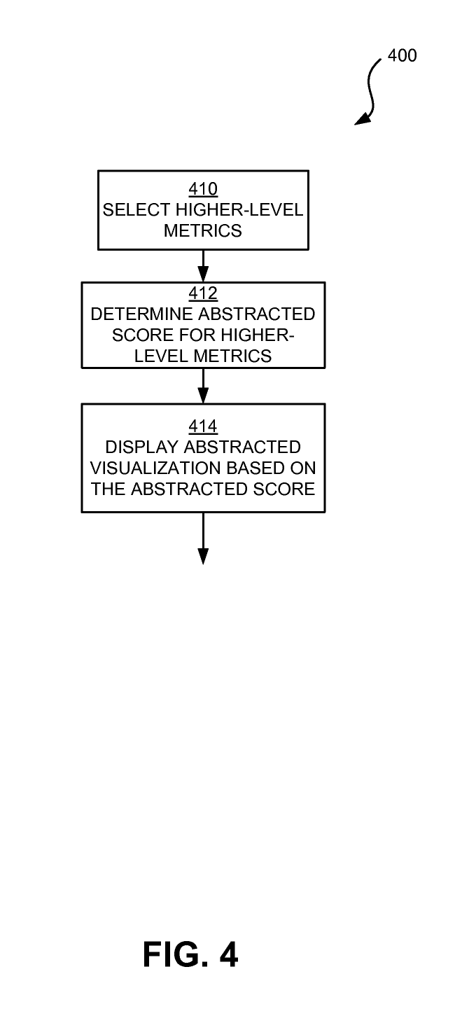

FIG. 4 illustrates a flowchart of a method 400 for creating an abstraction for a project, according to various embodiments. The method 400 may correspond to operation 232 in FIG. 2. The method 400 may involve creating an abstraction for the project. The abstraction may allow a manager/user to quickly view progress of the project. The method 400 may begin at operation 410.

In operation 410, the higher-level metrics are selected. The higher-level metrics are metrics that apply to the project as a whole during various stages of development. For example, the higher-level metric of timing may encompass the metrics for various timing tests including worst slack, number of misses, total negative slack, minimum and maximum capacitance violations, or minimum or maximum transition time violations. In various embodiments, the user may select which metrics are part of the higher-level metric.

In operation 412, the visualization engine can determine an abstracted score for the higher-level metrics. In various embodiments, the visualization engine can score the higher-level metric based on the combination of the metrics for a plurality of subprojects which may be further weighted by the stage of development. The higher-level metric may place more weight on metrics at a particular stage of development. For example, metrics for a chip design at a post-simulation may factor into the higher-level metric greater than metrics for a chip design at a pre-simulation stage of development. The higher-level metric may be based off of the metric for a given subproject within the project.

In various embodiments, an abstracted score can be determined by comparing the worst subproject score to the goal and providing the worst subproject score as a normalized value. The normalized value may result in a more symmetric shape in order to be more visually appealing to a user. The worst subproject score could be a percentage above/below the goal. The abstracted score can be based on comparing the median score of the subproject to the goal and providing the result as a normalized value.

In a circuit design project, the visualization engine may compare the median rank of sub-circuits on the circuit design project to the median of a history of sub-circuits from other designs at the same stage of development and provide the result of the comparison as a normalized value. In various embodiments, the visualization engine may compute area of the worst graphical shape for a particular subproject visualization (or worst N, or median) to the goal shape to determine a degree of conformity. The higher the degree of conformity with the goal shape, then the more likely the project is having the correct development. Thus, the ordering of axes is important and therefore axis order can be pre-determined based on knowledge of this area computation.

In operation 414, the visualization engine can display the abstracted visualization based on the abstracted score. The visualization engine can create an abstracted chart based on abstracted rank for each higher-level metric. The higher-level metrics may be different than lower-level metrics. A higher-level metric is a metric that represents a broad status of a project whereas a lower level metric is a metric that represents a value of a metric for a subproject. The abstracted score can be further abstracted again into a single abstraction for several projects with unique natural weights for each axis. The abstraction can be a recursive process to traverse several levels of abstraction.

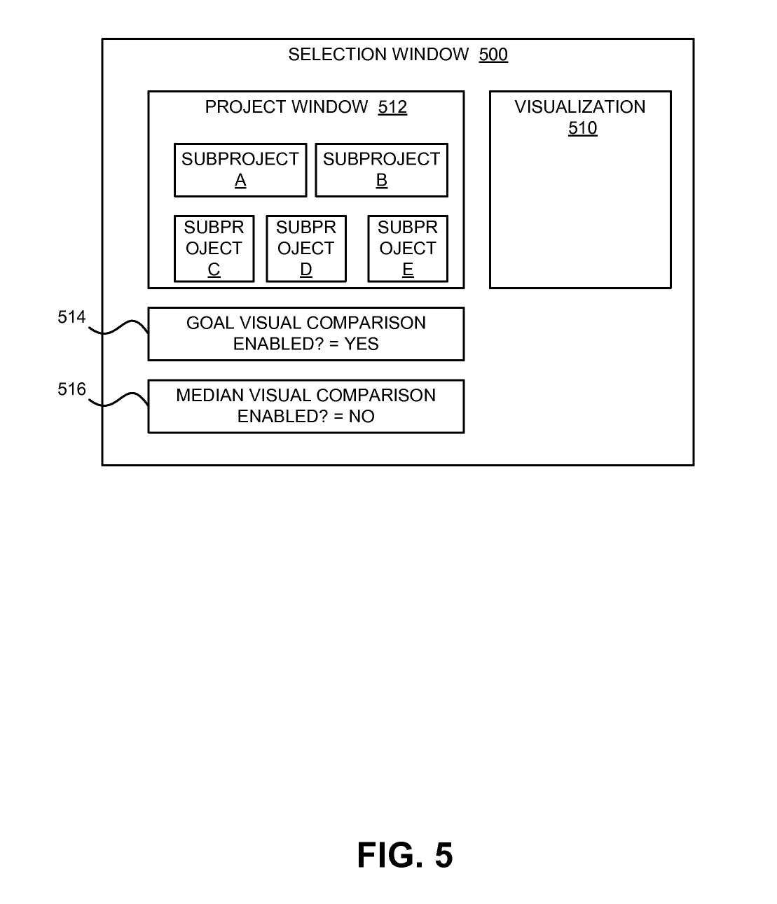

FIG. 5 illustrates a graphical user interface (GUI) selection window 500 for interacting with a visualization, according to various embodiments. The selection window 500 represents a sample GUI and embodiments of the disclosure should not be limited to the implementation in selection window 500.

The selection window 500 can have a project window 512 and a visualization 510. The project window 512 can illustrate the various subprojects within a project. For example, subprojects A, B, C, D, and E are illustrated. Examples of the visualization 510 are provided herein. The selection window 500 may also have the various display options for displaying a goal 514 or a median 516 that a user may interact with to produce a visualization 510.

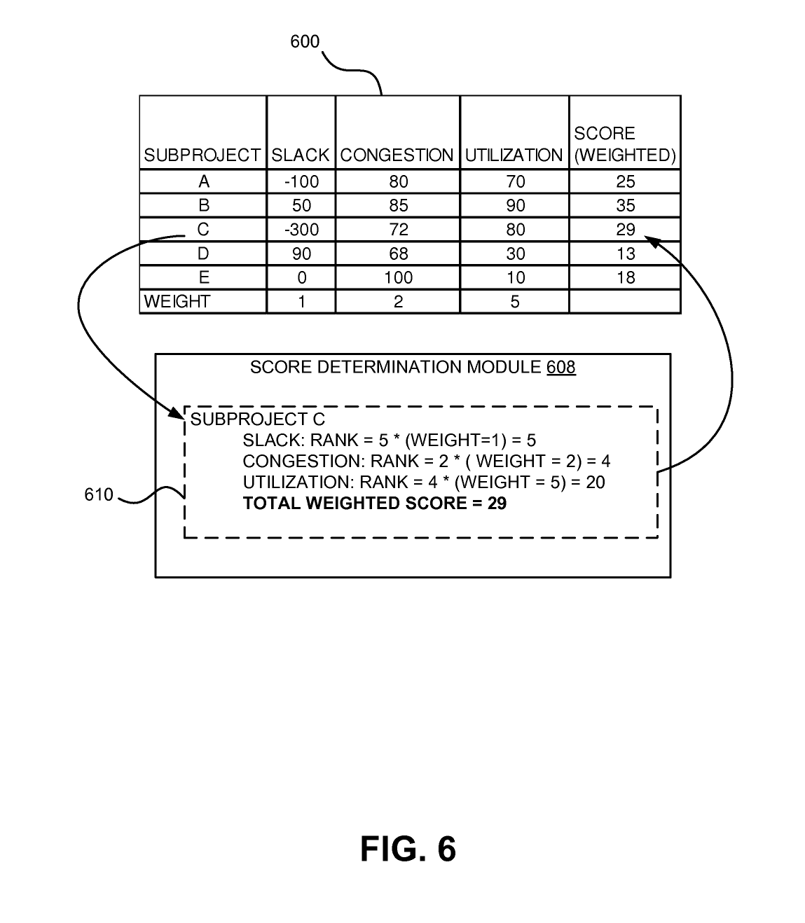

FIG. 6 illustrates a table 600 of data fields for subprojects and respective scores, according to various embodiments. Aspects of the table 600 may correspond to the table built in operation 216 in FIG. 2. The table 600 may include fields for subprojects and the values for the associated metrics of the subprojects. A score may be produced in accordance with operation 218 in FIG. 2.

To illustrate the calculation of the score, subproject C will be used to describe various aspects of the calculation. For subproject C, the score determination module 608 may begin by determining the rank of subproject C for the slack, congestion, and utilization metrics. The rank of subproject C for slack is 5th, for congestion is 2nd, and for utilization is 4th. The score determination module 608 may use the weights for slack, congestion, and utilization, to produce a total weighted score 610 of twenty-nine. In various embodiments, the distance between each weighted score for each subproject can be greater if the weights are modified. For example, if the slack has a weight of 20 instead of 1, then the overall weighted score would be higher.

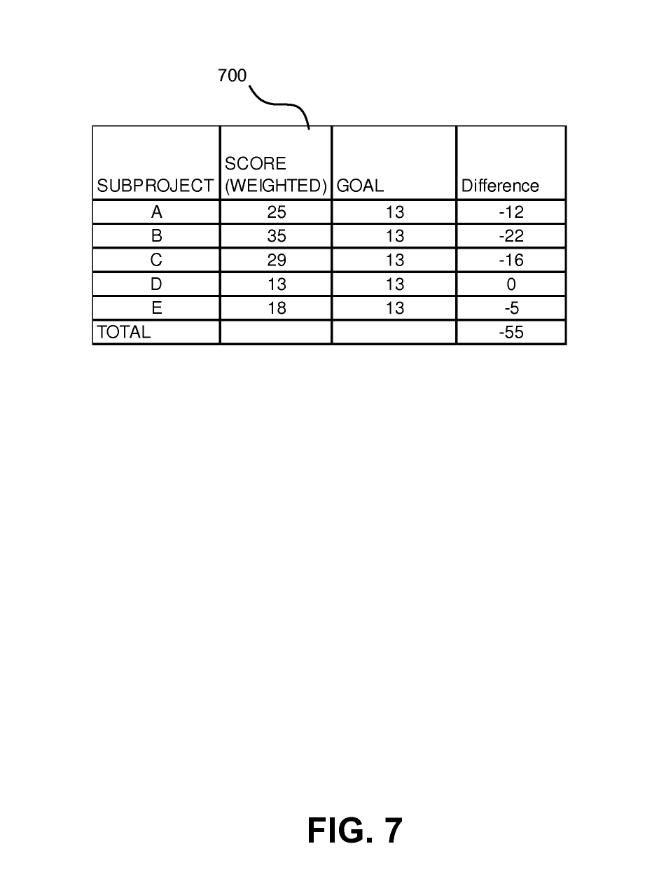

FIG. 7 illustrates a table 700 that demonstrates an abstraction, according to various embodiments. Aspects of table 700 may correspond to operation 232 in FIG. 2. In the table 700, scores for the subprojects of a project are listed. Once a scoring goal is determined for each subproject. Then the difference can be determined. The difference may be aggregated to produce an abstracted score for the project.

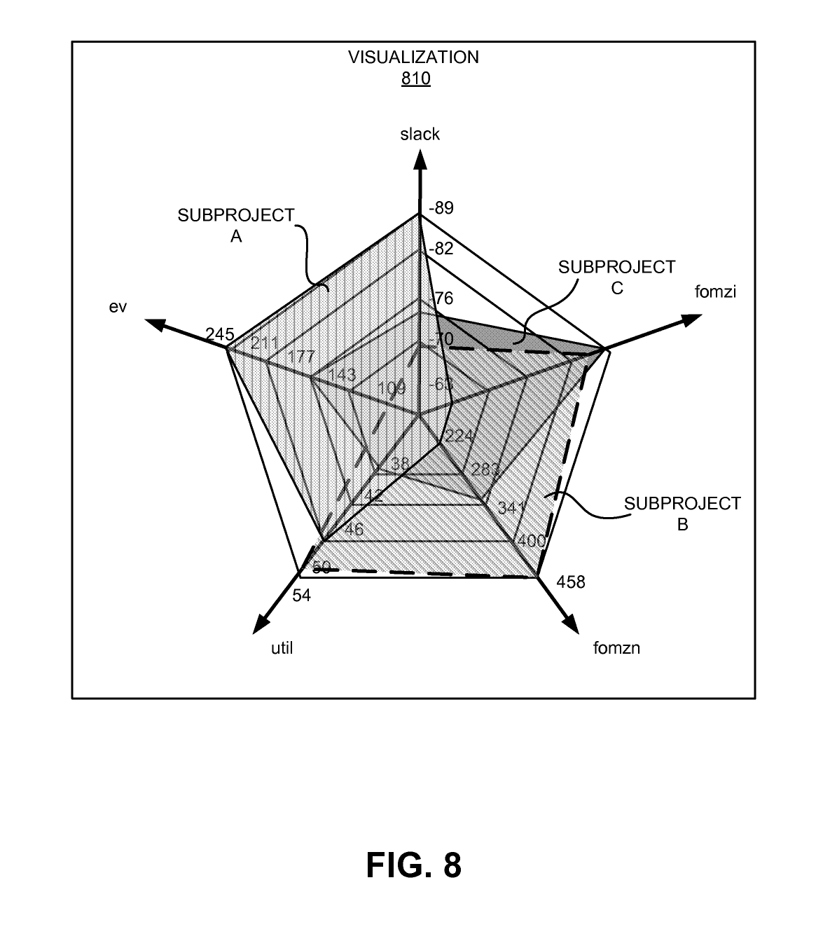

FIG. 8 illustrates a visualization 810 of three subprojects, according to various embodiments. The visualization 810 may correspond to three poorly performing subprojects: subproject A, B, and C. The visualization 810 may be able to include or exclude various subprojects or sub-designs and the amount of subprojects visualized may be limited by the computing resources. Various axis corresponding to different metrics may be weighted differently which causes the relative order to be impacted. Subproject C is considered the “worst” sub design even though most of subproject C's metric values are better than those in subproject A and B. In subproject C, the fomzi axis was heavily weighted which made the subproject C design end up as the “worst”.

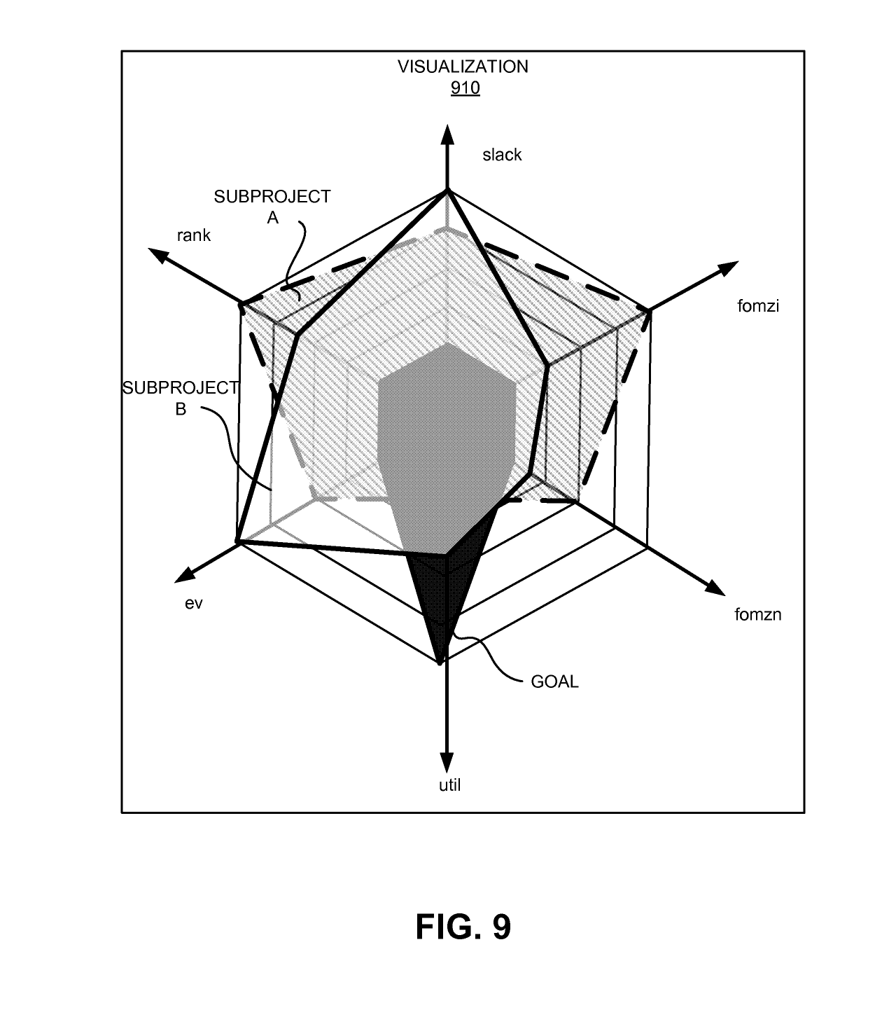

FIG. 9 illustrates a visualization 910 that includes a rank/score metric and a goal, according to various embodiments. The visualization 910 includes the addition of a Rank axis as well as a goal shape. The Rank axis conveys the normalized ranking value for each subproject. The Rank may be used interchangeably with the term score, according to various embodiments of the present disclosure. For instance, subproject A has the highest rank and may be colored to indicate a priority. The goal shape is not symmetric but shows where each subproject is expected to be for each metric. Shapes outside the goal are considered “behind the goal” and shapes inside the goal shape are “ahead the goal”. For example, subproject B is ahead of the goal for utility but behind the goal in ev. The goal may also be used to determine whether a subproject is ahead/behind schedule and is therefore useful for project management. Also note the shapes have changed due to the goal shape defining new minimum points on each axis.

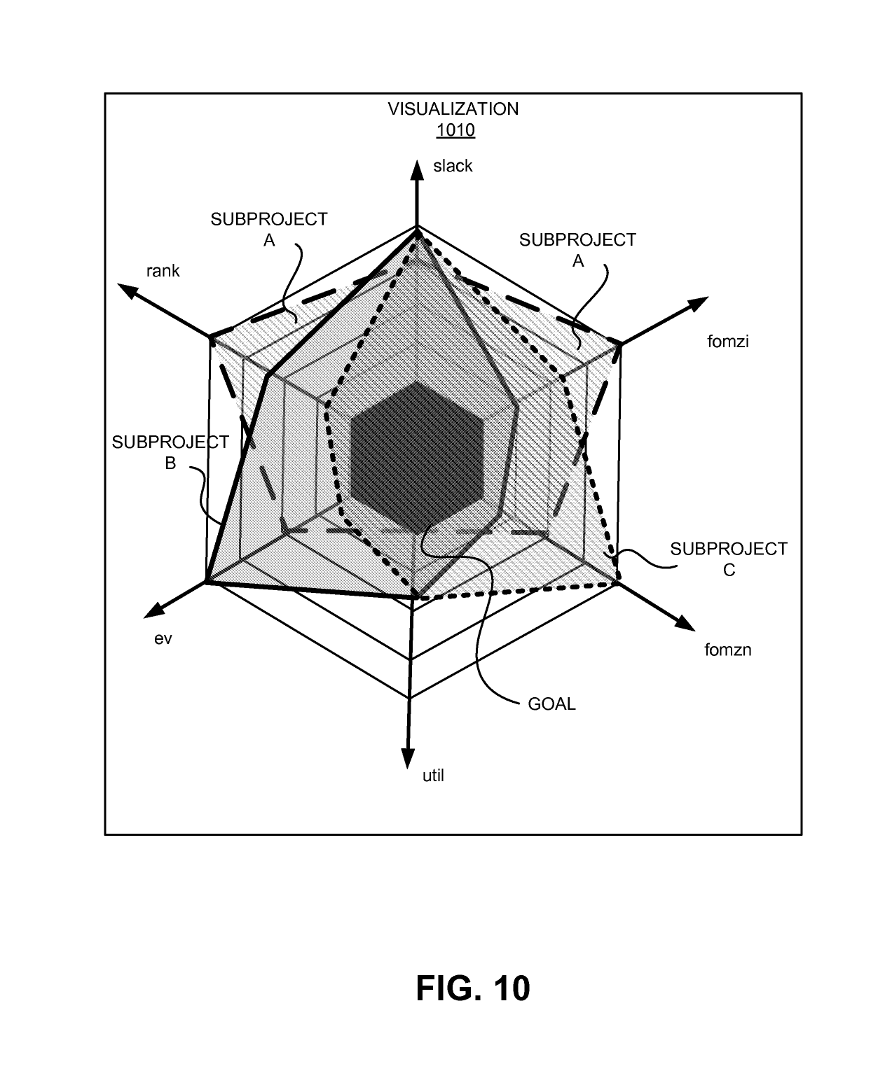

FIG. 10 illustrates a visualization 1010 that includes a symmetric goal, according to various embodiments. The visualization 1010 can include three subprojects, A, B, and C. To achieve this symmetry in the goal shape the min/max values for each axis is modified. In various embodiments, the median value may also be illustrated in the visualization 1010. The median value may be effectively modeled as another subproject, but is visually unique. In various embodiments, more subprojects and axis may be illustrated.

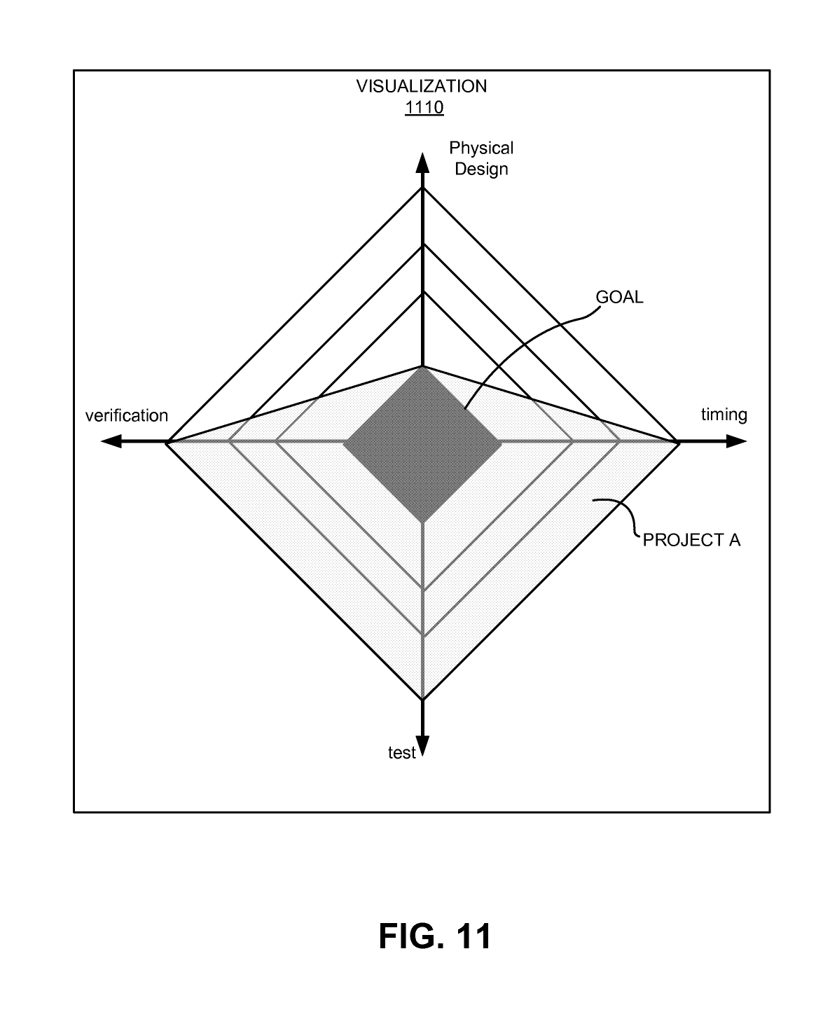

FIG. 11 illustrates a visualization 1110 of an abstraction, according to various embodiments. The visualization 1110 shows a goal and an abstraction for a project, project A. The project A abstraction may be based on the various higher-level metrics which correspond to an aggregation of various metrics for a subproject as mentioned herein.

In various embodiments, the visualization engine may utilize a rank/score of each subproject on the visualization, e.g., a spider chart, to determine an abstracted rank/score for the higher-level visualization. For example, if three spider charts are abstracted for Physical Design(PD), Timing, and Test, then the higher-level spider chart can include 3 axes, a PD axis, a Timing axis, and a Test axis. The value of the axis may be based on the abstracted rank/score for the applicable lower-level visualization.

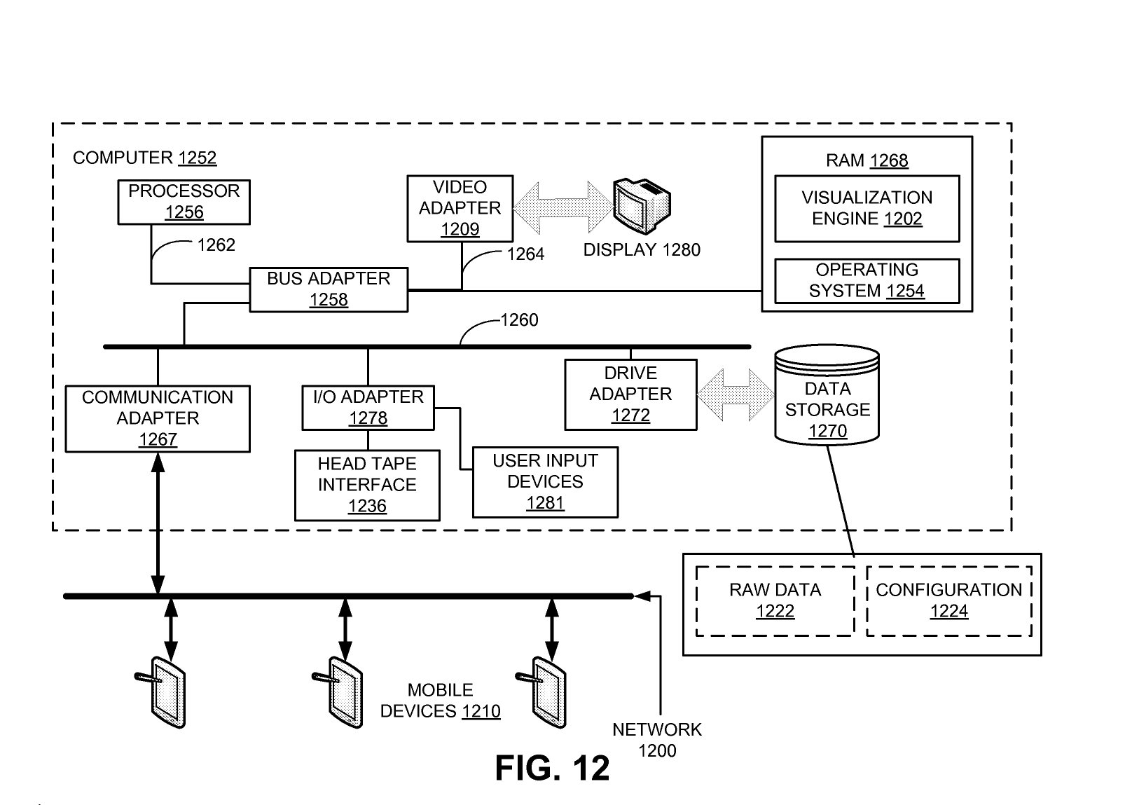

FIG. 12 illustrates a block diagram of automated computing machinery, according to various embodiments. The computing machinery may include example computer 1252 useful in performing aspects of the disclosure, according to various embodiments. The computer 1252 of FIG. 12 includes at least one computer processor 1256 or ‘CPU’ as well as random access memory 1268 (‘RAM’) which is connected through bus adapter 1258 to processor 1256 and to other components of the computer 1252.

The RAM 1268 may include a visualization engine 1202. The visualization engine 1202 can create visualizations of projects based on data. The visualization engine 1202 can have a scoring module that produces a score of the various subprojects of a project.

The RAM 1268 may include an operating system 1254. Operating systems useful for record filtering according to embodiments of the present invention include UNIX®, Linux®, Microsoft XP™, AIX®, IBM's i5/OS™, and others. The operating system 1254 are shown in RAM (1268), but many components of such software typically are stored in non-volatile memory also, such as, for example, on a disk drive 1270.

The computer 1252 may also include disk drive adapter 1272 coupled through expansion bus 1260 and bus adapter 1258 to processor 1256 and other components of the computer 1252. Disk drive adapter 1272 connects non-volatile data storage to the computer 1252 in the form of disk drive 570. Disk drive adapters useful in computers include Integrated Drive Electronics (‘IDE’) adapters, Small Computer System Interface (‘SCSI’) adapters, and others. Non-volatile computer memory also may be implemented for as an optical disk drive, electrically erasable programmable read-only memory (so-called ‘EEPROM’ or ‘Flash’ memory), RAM drives, and so on.

The data storage 1270 may include one or more storage devices in a tiered or non-tiered configuration. The data storage 1270 can include one or more raw data 1222 and configurations 1224 that is used by the visualization engine 1202 to produce a visualization. The visualization may appear on the display 1280.

The example computer 1252 includes one or more input/output (I/O′) adapters 1278. I/O adapters implement user-oriented input/output through, for example, software drivers and computer hardware for controlling output to display devices such as computer display screens, as well as user input from user input devices 1281 such as keyboards and mice. The example computer 1252 includes a video adapter 1209, which is an example of an I/O adapter specially designed for graphic output to a display device 1280 such as a display screen or computer monitor. Video adapter 1209 is connected to processor 1256 through a high speed video bus 1264, bus adapter 1258, and the front side bus 1262, which is also a high speed bus.

The example computer 1252 includes a communications adapter 1267 for data communications with other computers 1210, e.g., mobile devices, and for data communications with a data communications network 1200. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters include modems for wired dial-up communications, Ethernet (IEEE 802.3) adapters for wired data communications network communications, and IEEE 802.77 adapters for wireless data communications network communications.

Referring to FIGS. 1-12. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method of visualizing a project on a computing device, comprising:
determining a plurality of metrics for the project, the project having a plurality of subprojects;
accessing data for each metric from the plurality of metrics, the data concerning a subproject from the plurality of subprojects;
building a table having the data for a metric matched to the subproject;
calculating a numerical score based off of the table that represents progress of a first subproject relative to a second subproject with regard to the metric; and
creating a visualization that includes the plurality of metrics and the numerical score of the first subproject.

2. The method of claim 1, further comprising:
determining a stage of development of the project; and
determining, responsive to the stage of development of the project, the plurality of metrics.

3. The method of claim 1, wherein calculating the numerical score further comprises:
analyzing the data for the plurality of metrics of the first subproject;
determining the numerical score of the first subproject based on a relationship of a first metric from the first subproject to the first metric from the second subproject; and
weighting the numerical score by applying a weight for the first metric.

4. The method of claim 1, further comprising:
determining a goal value for each metric from the plurality of metrics in the project;
wherein a created visualization includes the goal value for each metric.

5. The method of claim 4, wherein determining the goal value includes:
determining a stage of development of a project; and
determining a value of the plurality of metrics for a historical project at the stage of development.

6. The method of claim 5, wherein creating the visualization includes:
aligning the goal value with a specified percentage from a center of the visualization by adjusting a minimum and a maximum for an axis of the visualization.

7. The method of claim 4, further comprising:
creating an abstraction of the project by:
selecting a goal value for a metric,
determining a percentage fulfillment of the goal value by the metric from a subproject, and
creating an abstraction score based on the percentage fulfillment.

8. The method of claim 1, further comprising:
determining a plurality of median metric values for the project based on a plurality of metric values for a subproject; and
creating a visualization with each median metric value.
